(19) United States
(12) Patent Application Publication
(10) Pub. No.: US 2007/0165958 A1
(43) Pub. Date: Jul. 19, 2007

(54) Method for compressing/decompressing video information

(75) Inventor: Yann Picard, Paris (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,061

(22) PCT Filed: Jan. 10, 2005
(86) PCT No.: PCT/IB05/00049

§ 371 Date: Jul. 10, 2006

(30) Foreign Application Priority Data
Jan. 16, 2004 (EP) 04290121.5

(51) Int. Cl. G06K 9/36

(52) U.S. Cl. 382/238; 382/236

(57) ABSTRACT

The invention relates to a method for compressing video information in a video sequence (Iₜ, Iₜ₊₁). According to the invention, this method comprises the steps of: . segmenting a first video frame (Bₜ) into segments (S_{t,i}); . for each segment (S _{t,i}) of the video frame (Bₜ): —searching, in a second video frame (Iₜ₊₁), a corresponding predicted segment (I) which matches with the segment (S_{t,i}) of the first video frame (Bₜ); —calculating a raw set of motion parameters (II) describing the motion between the segment (S _{t,i}) and the corresponding predict segment (I); and . for each corresponding predict segment (I): —searching, in the first video frame (Bₜ), a corresponding segment (III) that matches with the predict segment (I) of the second video frame (I ₜ₊₁); —calculating a best set of motion parameters (IV) which describes the motion between the corresponding segment (III) and the predict segment (I).

### FIELD OF THE INVENTION

The present invention relates to a method for compressing/decompressing video information, and to corresponding compressing and decompressing devices. It also relates to a computer program product for carrying out said method, to compressed data obtained by implementation of said method, and to devices for compressing and decompressing video information.

### BACKGROUND OF THE INVENTION

The current standards belong to the MPEG family like MPEG-1, MPEG-2 and MPEG-4 (see for instance MPEG-4 Visual coding standard ISO/IEC 14496-2, document available at ISO, referred here under the MPEG-4 document number w3056) and to the ITU H.26X family like H.261, H.263 and extensions, and H.264.

Most video coding standards take advantage of the fact that there are some redundancies between subsequent frames of a video sequence. In most video compression algorithms, each frame is subdivided into segments which can be regular square blocks, as in MPEG-4, or square or rectangular blocks as in H.264. When decompressing the compressed data, each segment of a following frame is obtained by calculation of a prediction, based on a corresponding segment of a previous frame by using motion information generally called motion vector, and correction or residual information generally called residual image defining the differences between the segment and its prediction and more generally between the frame and its prediction. The compression standards provide a way of encoding the motion information and the correction information for retrieving a following frame based on a previous known frame.

Mainly, two approaches are used by the compression standards. A first approach is named the backward approach. It is implemented in MPEG and ITU H.26X standards. In the backward approach, for each segment of a following frame, the compression method tries to find the segment of the previous frame that is the closest to it or at least less far from it. This may cause problems for segments that appear in the following frame and not in the previous frame. Still, for any segment that is present in both the previous and the following frames, this system gives the best prediction, for a given motion model, providing a full search of the motion parameters is done, that is to say that any possible parameters are considered. The problem with the backward approach is that, in many cases, the used frame segmentation does not coincide with the frame segmentation into “real” objects that may have different overall motions.

The second approach is named the forward approach. This approach is disclosed for example in WO-00/64167. It uses a segmentation based coding scheme using “real” objects of the frame. In the forward approach, for each segment of a previous frame, which is considered as an independent object, the best match is searched in the following frame, that is to say the method tries to find what the object became between the two frames. The segments of the following frames that are predicted are not optimally predicted with regard to the considered motion model. It is not sure to have the best possible prediction of the following frame from the previous frame, even with fall search motion estimation. Indeed the optimisation is performed regarding what one has, i.e. the previous frames, and not regarding what one wants to have, i.e. the new frame.

### SUMMARY OF THE INVENTION

It is therefore the object of the invention to provide a video compression method—and an associated decompression method—that enables to optimise the segmentation used for the prediction of a following frame based on a known previous frame.

To this end, the invention relates to a method for compressing video information in a video sequence (Iₜ, Iₜ₊₁) comprising the steps of:
considering in said sequence a first video frame (Bₜ) containing image data;
segmenting said first video frame (Bₜ) into segments (S_{t,i});
for each segment (S_{t,i}) of the first video frame (Bₜ):
   searching, in a second video frame (Iₜ₊₁) following the first video frame (Bₜ) in the video sequence, a corresponding predicted segment (S_{t+1,i}^{p,forward}) which matches with the segment (S_{t,i}) of the first video frame (Bₜ) according to a predetermined similarity measure;
   calculating a raw set of motion parameters (M_{t,i}^{p}) describing the motion between the segment (S_{t,i}) of the first video frame (Bₜ) and the corresponding predicted segment (S_{t+1,i}^{p,forward}) of said second video frame (Iₜ₊₁); and
for each corresponding predicted segment (S_{t+1,i}^{p,forward}) of the second video frame (Iₜ₊₁):
   searching, in the first video frame (Bₜ), a corresponding segment (S_{t,i}^{p,backward}) that matches with the predicted segment (S_{t+1,i}^{p,forward}) of the second video frame (Iₜ₊₁) according to a predetermined similarity measure;
   calculating a best set of motion parameters (M_{t,i}^{p}+ΔM_{t,i}^{p}) describing the motion between the corresponding segment (S_{t+1,i}^{p,backward}) of the first video frame (Bₜ) and the predicted segment (S_{t,i}^{p,forward}) of the second video frame (Iₜ₊₁), said best set of motion parameters consisting in the raw set of motion parameters (M_{t,i}^{p}) corrected by a motion parameters correction (ΔM_{t,i}^{p}).

As seen later in the description, such a method has the advantage to provide a segmentation of the following frame which is optimised before applying a backward approach to determine the best set of motion parameters.

Additional features are recited in the sub-claims 2 to 8.

Another object of the invention is to propose a method for decompressing video information in a video sequence (Iₜ, Iₜ₊₁) comprising:
considering a first video frame (Bₜ) containing image data;
segmenting said first video frame (Bₜ) into segments (S_{t,i});
for each segment (S_{t,i}) of the first video frame (Bₜ), defining a projected segment (S_{t+1,i}^{p}) by applying to the segment (S_{t,i}) of the first video frame (Bₜ), a raw set of motion parameters (M_{t,i}^{p}) describing the motion between the segment (S_{t,i}) of the first video frame (Bₜ) and the corresponding projected segment (S_{t+1,i}^{p}) and
for each corresponding projected segment (S_{t+1,i}^{p}):
finding in the first video frame (Bₜ) a corresponding improved segment (S_{t,i}^{b}) using both the raw set of motion parameters (M_{t,i}^{p}) and a motion parameters correction (ΔM_{t,i}^{p}), the corresponding improved segment (S_{t,i}^{b}) being the segment of the first video frame (Bₜ) that would be projected on the corresponding projected segment (S_{t+1,i}^{p}) by applying to it the raw set of motion parameters (M_{t,i}^{p}) corrected by the motion parameters correction (ΔM_{t,i}^{p}); and
defining a corrected projected segment (S_{t+1,i}^{p,o,c}) by applying the raw set of motion parameters (M_{t,i}^{p}) corrected by the motion parameters correction (ΔM_{t,i}^{p}) to the corresponding improved segment (S_{t,i}^{b}).

It also concerns a computer program product for a data processing unit, comprising a set of instructions, which, when loaded into said data processing unit, causes the data processing unit to carry out the compressing method previously mentioned.

In addition, the invention also relates to a device for compressing video information in a video sequence (Iₜ, Iₜ₊₁) comprising:
means for segmenting the first video frame (Bₜ) containing image data into segments (S_{t,i});
means for searching, in a second video frame (Iₜ₊₁) following the first video frame (Bₜ) in the video sequence, a corresponding predicted segment (S_{t+1,i}^{p,forward}) which matches with the segment (S_{t,i}) of the first video frame (Bₜ) according to a predetermined similarity measure, for each segment (S_{t,i}) of the first video frame (Bₜ);
means for calculating a raw set of motion parameters (M_{t,i}^{p}) describing the motion between the segment (S_{t,i}) of the first video frame (Bₜ) and the corresponding predicted segment (S_{t+1,i}^{p,forward}) of the second video frame (Iₜ₊₁), for each segment (S_{t,i}) of the first video frame (Bₜ);
means for searching, in the first video frame (Bₜ), a corresponding segment (S_{t,i}^{p,backward}) that matches with the predicted segment (S_{t+1,i}^{p,forward}) of the second video frame (Iₜ₊₁) according to a predetermined similarity measure, for each corresponding predicted segment (S_{t+1,i}^{p,forward}) of the second video frame (Iₜ₊₁);
means for calculating a best set of motion parameters (M_{t,i}^{p}+ΔM_{t,i}^{p}) describing the motion between the corresponding segment (S_{t,i}^{p,backward}) of the first video frame (Bₜ) and the predicted segment (S_{t+1,i}^{p,forward}) of the second video frame (Iₜ₊₁), said best set of motion parameters consisting in the raw set of motion parameters (M_{t,i}^{p}) corrected by a motion parameter correction (ΔM_{t,i}^{p}), for each corresponding predicted segment (S_{t+1,i}^{p,forward}) of the second video frame (Iₜ₊₁). The invention still relates to a device for decompressing video information in a video sequence (Iₜ, Iₜ₊₁) comprising:
means for segmenting said first video frame (Bₜ) containing image data into segments (S_{t,i});
means for defining a projected segment (S_{t+1,i}^{p}) for each segment (S_{t,i}) of the first video frame (Bₜ), by applying to the segment (S_{t,i}) of the first video frame (Bₜ), a raw set of motion parameters (M_{t,i}^{p}) describing the motion between the segment (S_{t,i}) of the first video frame (Bₜ) and the corresponding projected segment (S_{t+1,i}^{p});
means for finding, in the first video frame (Bₜ), a corresponding improved segment (S_{t,i}^{b}) using both the raw set of motion parameters (M_{t,i}^{p}) and a motion parameters correction (ΔM_{t,i}^{p}), the corresponding improved segment (S_{t,i}^{b}) being the segment of Bₜ that would be projected on the corresponding projected segment (S_{t+1,i}^{p}) by applying to it the raw set of motion parameters (M_{t,i}^{p}) corrected by the motion parameters correction (ΔM_{t,i}^{p}), for each corresponding projected segment (S_{t+1,i}^{p}); and
means for defining a corrected projected segment (S_{t+1,i}^{p,o,c}) by applying the raw set of motion parameters (M_{t,i}^{p}) corrected by the motion parameters correction (ΔM_{t,i}^{p}) to the corresponding improved segment (S_{t,i}^{b}), for each corresponding projected segment (S_{t+1,i}^{p}). It also concerns compressed data corresponding to a video sequence as obtained by the previously mentioned compressing method.

### BRIEF DESCRIPTION OF THE DRAWINGS

The present invention will be now described, by way of example, with reference to the accompanying drawings in which:

FIG. 1 is a schematic view of a typical processing chain for a video sequence made of successive frames;

FIG. 2 is a flow chart showing the video compression algorithm of the method for encoding a sequence of frames according to the invention;

FIG. 3 is a schematic view of a processed frame at successive steps during the compression operation;

FIG. 4 is a flow chart showing the video decompression algorithm of the method for decoding the compressed data corresponding to the compression method of a sequence of frames according to the invention; and

FIG. 5 is a schematic view of a processed frame at successive steps during the decompression operation.

### DETAILED DESCRIPTION OF THE INVENTION

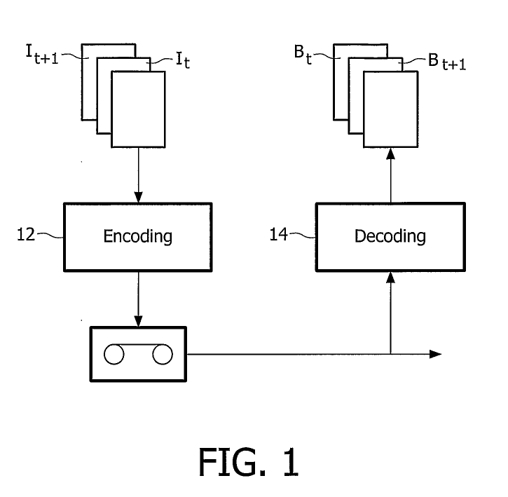

FIG. 1 shows a typical processing chain for a video sequence made of successive frames, each frame containing image data. This chain includes an encoder 12 adapted to receive a sequence of frames. These frames, provided for example by a digital camera, are arrays of pixels, each pixel being characterized by color parameters, which can be chrominance and luminance or Red, Green and Blue values for example. In the following, the t^{th} frame of an input sequence is denoted Iₜ.

The encoder 12 is adapted to implement a video compression method according to the invention and to output encoded data that are compressed. The compression method takes advantage of the fact that there are some redundancies between subsequent frames of the video sequence. The encoded data are then stored in a support like a tape or are transmitted over a medium like a wireless network. The processing chain finally comprises a decoder 14 that is adapted to decompress the encoded data and to provide a sequence of frames. The decoder 14 is adapted to implement a video decompression method according to the invention. In the following, the t^{th} frame of a decompressed sequence is denoted Bₜ.

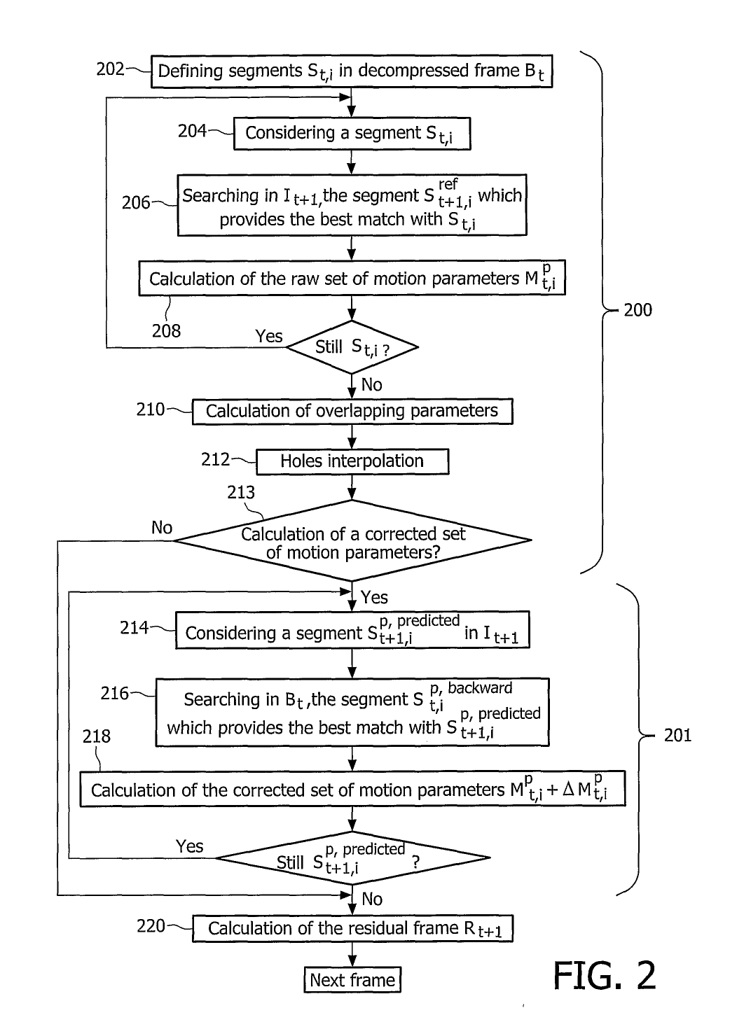

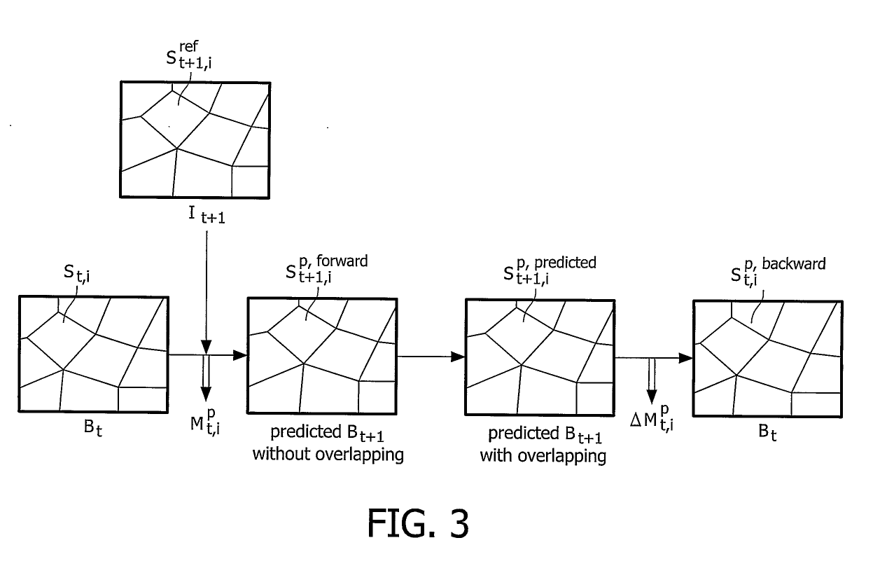

FIG. 2 shows the video compression algorithm carried out in the encoder 12. FIG. 3 shows the following processed frames during the implementation of the compression algorithm. This algorithm of FIG. 2, implemented by a processing unit like a DSP driven by an adapted software program, is repeated for each frame of the sequence of frames to be encoded. The steps shown in FIG. 2 concern the encoding of frame Iₜ₊₁. It is assumed that the previous frame Iₜ has already been encoded and that the decompressed frame Bₜ corresponding to frame Iₜ is known.

Roughly, the method consists in two main stages. In a first stage 200, a first set of motion parameters is defined by using a forward approach to project segments of the previous frame Iₜ in order to predict the following frame I_{t+1.}. Once projected, a predicted segmentation of the following frame Iₜ₊₁ is provided. This segmentation is more likely to coincide with real objects of the following frame Iₜ₊₁ than an arbitrary segmentation, a grid of blocks for example. Without considering the “holes” of the predicted segmentation as segments (they are not predicted by any part of the frame Iₜ), for each projected segment, a corresponding segment called a predicted segment is provided in the prediction, and above all, a set of motion parameters. In order to refine the prediction if necessary, a new motion estimation is performed in a second stage 201, this time by using the backward approach on the predicted segments.

The first stage 200 is based on a forward approach, which means that segments of the previous frame Iₜ are searched in the following frame Iₜ₊₁. The compression method will now be disclosed in details.

At step 202, a segmentation of decompressed frame Bₜ is defined and stored. The segmentation of Bₜ consists in defining a subdivision of Bₜ into segments S_{t,i}. A set of segmentation parameters is determined. It defines the segmentation process that is implemented. Advantageously, the segment boundaries coincide with object boundaries in the frame Bₜ. Thus, the segments are “real” objects in the picture corresponding to frame Bₜ. In the following, all the segments S_{t,i} are processed subsequently. Thus, a segment S_{t,i} is considered in Bₜ at step 204.

At step 206, a corresponding segment S_{t+1,i}^{ref} is searched in the following frame Iₜ₊₁ to be encoded. The corresponding segment S_{t+1,i}^{ref} is the segment of frame Iₜ₊₁ which provides the best match with segment S_{t,i} according to a given similarity measure. The similarity measures are known per se and will not be disclosed.

At step 208, some parameters that enable to retrieve S_{t+1,i}^{ref} are stored. In particular a raw set of motion parameters M_{t,i}^{p} is calculated. These motion parameters define the changes in the position of S_{t+1,i}^{ref} with respect to S_{t,i}. For example, the set of motion parameters M_{t,i}^{p} defines a translational motion. According to the forward approach, the predicted segment denoted S_{t+1,i}^{p,forward} and the raw set of motion parameters M_{t,i}^{p} are defined as follows:
S_{t+1,i}^{p,forward}=MC(S_{t,i},M_{t,i}^{p}), where MC(S_{t,i}, M_{t,i}^{p}) is the motion compensation operation using M_{t,i}^{p} as motion parameters;
M_{t,i}^{p}=arg min (diff(MC(S_{t,i}, M),S_{t+1,i,M}^{ref})) (for example);
   M in motion
      search range
      where S_{t+1,i,M}^{ref} is the segment of the following frame Iₜ₊₁ that coincides with MC(S_{t,i}^{ref}, M) and diff(a,b) measures the similarity of a and b (the higher the measure, the less a and b are alike—it can be, for example, the sum of square differences of the pixel color values over the whole segment);
S_{t+1,i}^{p,forward} is a raw predicted segment.

At this step, no processing is done to deal with overlapping between the different predicted segments S_{t+1,i}^{p,forward}. The overlapping issues are dealt with as disclosed below. Steps 202-208 are repeated until all the segments S_{t,i} of previous decompressed frame Bₜ are considered. Thus, for each segment S_{t,i}, a corresponding predicted segment S_{t+1,i}^{p,forward} is defined in the prediction together with a raw set of motion parameters M_{t,i}^{p} called forward motion parameters.

Once every segment of the previous decompressed frame Bₜ is projected, some raw predicted segments may overlap each other. Some decisions is made at step 210 for solving the intersection between adjacent segments. Thus, overlapping parameters are calculated. According to a first embodiment, it is determined which segment is in front of which. How to make these decisions is not within the scope of the present invention. When it is done, predicted segments have their final shape, i.e. the original shape minus the possibly hidden parts. According to another embodiment, a merge parameter α is determined for each pair of adjacent segments. For each pixel of the intersection between the adjacent segments, a value of the pixel Pₒᵥₑᵣₗₐₚ is defined by: Pₒᵥₑᵣₗₐₚ=αP_{segment1}+(1−α)P_{segment2}, where P_{segment1} and P_{segmeent2} are the values of the corresponding overlapping pixels of both segments.

The prediction of the following frame Iₜ₊₁ resulting from the set of predicted segments S_{t,i}^{p,forward} may have holes. These holes correspond to newly uncovered parts of the following frame Iₜ₊₁. The holes are considered as new predicted segments or their contents are stored at step 212. Holes processing is not within the scope of the invention. In a possible embodiment, holes are added to the projected segmentation as new segments to be processed in the next step of the algorithm. They could also be merged with an existing predicted segment, or simply be stored as holes to be processed after motion processing was done. In any case, information regarding holes is encoded and stored. After step 212, a set of S_{t+1,i}^{p,predict} segments that corresponds to the set of S_{t+1,i}^{p,forward} segments after having been processed for holes and overlapping is defined. At step 213, it is decided whether a calculation of a new best set of motion parameters by using a backward approach is necessary. If it is necessary, the second stage 201 is performed and a corresponding flag [YES] is memorized. If not, a corresponding flag [NO] is memorized and step 220 is directly performed for calculating residual frame Rₜ₊₁ as will be disclosed below.

If necessary, a new motion estimation is performed in the second stage 201, by using a backward approach based on the predicted segments S_{t+1,i}^{p,predicted}. At step 214, a predicted segment S_{t+1,i}^{p,predicted} as provided by the forward approach is considered. At step 216, a search is carried out in the previous frame Bₜ to find the segment of frame Bₜ denoted S_{t,i}^{p,backward} that is the closest to the considered predicted segment S_{t+1,i}^{p,predicted} according to the given similarity measure. At step 218, the new best set of motion parameters denoted M_{t,i}^{p}+ΔM_{t,i}^{p} is calculated. ΔM_{t,i}^{p} is a motion parameters correction such that M_{t,i}^{p}+ΔM_{t,i}^{p} defines the motion from S_{t,i}^{p,backward} to S_{t+1,i}^{p,predicted}. The new best prediction for S_{t,i}^{p,backward} is searched in a small area around the segment defined by applying the forward motion parameters M_{t,i}^{p} to the predicted segment S_{t+1,i}^{p,predicted}. Steps 214-218 are repeated until all the predicted segments S_{t+1,i}^{p,predicted} are considered. At this point, remaining holes are processed.

At step 220, a residual frame Rₜ₊₁ is computed and encoded. The encoding method is not within the scope of this invention. In a possible embodiment, residual frame Rₜ₊₁ may be encoded on a segment basis using the projected segmentation (S_{t+1,i}^{p,predicted} and holes). The residual frame Rₜ₊₁ defines the structural differences between the image prediction Bₜ₊₁^{predicted} (the reunion of all predicted segments S_{t+1,i}^{p,predicted} and processed holes) and the predicted image Iₜ₊₁. According to the invention, the best set of motion parameters M_{t,i}^{p}+ΔM_{t,i}^{p} is stored with a multi-layer motion description. The first layer contains the raw set of motion parameters M_{t,i}^{p} and the flag [YES] or [NO] indicating if the decoder 14 should wait for an additional layer. The second layer contains the motion parameters correction ΔM_{t,i}^{p}. At the end of the compression method, the compressed data provided by the encoder 12 are the segmentation parameters, the motion parameters M_{t,i}^{p} or the best set of motion parameters M_{t,i}^{p}+ΔM_{t,i}^{p} of each segment contained in the multi-layer motion description, the overlapping information, the holes information and the residual frame Rₜ₊₁.

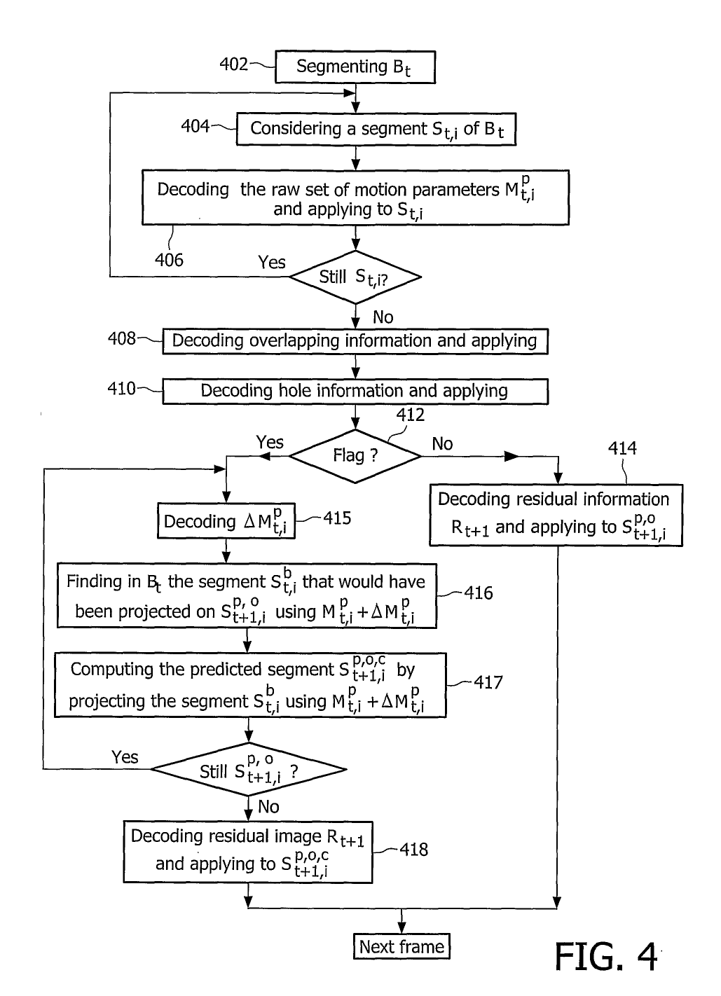

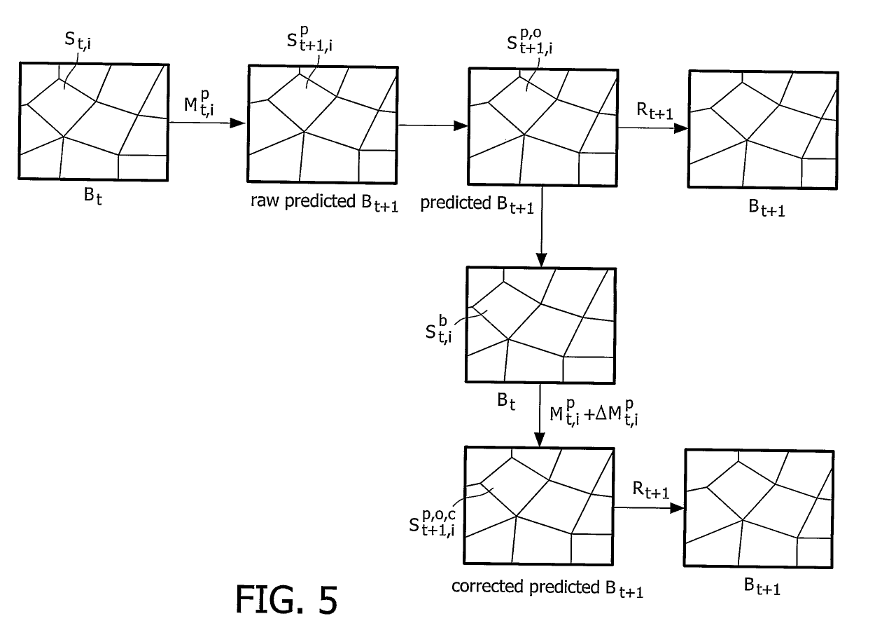

Upon reception of the compressed data, the decoder 14 applies the algorithm disclosed on FIG. 4. FIG. 5 shows the processed frames during the implementation of the decompression method. The same algorithm is repeated for each frame Bₜ₊₁ to be decompressed. It is assumed that a previously decoded frame Bₜ is known and that the following frame Bₜ₊₁ has to be decompressed.

At step 402, frame Bₜ is segmented based on the set of segmentation parameters by using the same algorithm and the same settings as its counter part Bₜ at the decoder side.

These settings are set once and for all or are transmitted with encoded frames. The segments of Bₜ are denoted S_{t,i} for clarity reason. A segment S_{t,i} of Bₜ is considered at step 404 and the first layer motion parameters M_{t,i}^{p} of segment S_{t,i} are decoded and applied at step 406. A predicted segment S_{t+1,i}^{p} is obtained. Steps 404-406 are carried out for all the segments of the decompressed frame Bₜ.

Overlapping parameters are decoded and applied at step 408 to segment S_{t+1,i}^{p} to obtain a new segment denoted S_{t+1,i}^{p,o}. Since the reunion of the segments S_{t+1,i}^{p,o} may not cover the all frame, —the holes of Bₜ₊₁ are predicted according to hole information contained in the compressed data, at step 410. Then, it is checked in step 412, if the flag contained in the first layer of the motion description indicates that additional motion information is contained in the second layer. If no additional motion information is contained in the compressed data, residual frame decoding is directly performed. A following predicted frame is defined by all the segments S_{t+1,i}^{p,o}. At this point, hole filing is performed, defining a predicted frame Bₜ₊₁^{pred}. Residual frame Rₜ₊₁ is decoded and applied to the predicted frame Bₜ₊₁^{pred} to compute the final decoded frame Bₜ₊₁, at step 414.

If additional motion information is contained in the compressed data, at step 415 motion parameters correction ΔM_{t,i}^{p} is decoded and a corresponding improved segment S_{t,i}^{b} is retrieved in the decoded frame Bₜ at step 416. This corresponding improved segment S_{t,i}^{b} is the segment of Bₜ which would be projected on segment S_{t+1,i}^{p,o} if the corrected motion parameters M_{t,i}^{p}+ΔM_{t,i}^{p} were applied to it. The corrected motion parameters M_{t,i}^{p}+ΔM_{t,i}^{p} are the raw set of motion parameters M_{t,i}^{p} corrected by the motion parameters correction ΔM_{t,i}^{p}. At step 417, the projection of S_{t,i}^{b} using M_{t,i}^{p}+ΔM_{t,i}^{p} provides a corrected predicted segment S_{t+1,i}^{p,o,c}. A following corrected predicted frame is defined by all the segments S_{t+1,i}^{p,o,c}. At this point, hole filling is performed, defining a final corrected predicted frame Bₜ₊₁^{pred}. Then the residual frame Rₜ₊₁ is decoded and applied to the final corrected predicted frame Bₜ₊₁^{pred}, at step 418 to provide the final decoded frame Bₜ₊₁.

Advantageously, according to a particular embodiment for a given segment, a motion vector is defined. This motion vector contains the first and second layers of the motion description. The forward motion parameters are the integer part of this vector. The predicted segmentation S_{t+1,i}^{p} is computed according to this truncated motion information contained in the vector by only considering the integer part.

For the backward motion correction of each predicted segment S_{t+1,i}^{p,o}, the full precision vector is used. In this case, there is only one actual layer of motion parameters: backward and forward motions are contained in one motion symbol. Still, the motion description is two-layered.

In the previous embodiment, calculation of overlapping parameters at step 210 and the corresponding step 408 are performed for a predicted frame Bₜ₊₁, after all the segments have been predicted. According to an alternative embodiment, overlapping parameters are calculated for each segment after step 208. Thus, they are calculated and encoded segment by segment. Accordingly, the overlapping parameters are applied segment by segment just after step 406 in the decompression method.

There are numerous ways of implementing functions by means of items of hardware or software, or both. In this respect, the drawings are very diagrammatic, and represent only possible embodiments of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description, with reference to the drawings, illustrates rather than limits the invention. There are numerous alternatives, which fall within the scope of the appended claims. The words “comprising” or “comprise” do not exclude the presence of other elements or steps than those listed in a claim. The word “a” or “an” preceding an element or step does not exclude the presence of a plurality of such elements or steps.

1. A method for compressing video information in a video sequence (Iₜ, Iₜ₊₁) comprising the steps of:
considering in said sequence a first video frame (Bₜ) containing image data;
segmenting said first video frame (Bₜ) into segments (S_{t,i});
for each segment (S_{t,i}) of the first video frame (Bₜ):
searching, in a second video frame (Iₜ₊₁) following the first video frame (Bₜ) in the video sequence, a corresponding predicted segment (S_{t+1,i}^{p,forward}) which matches with the segment (S_{t,i}) of the first video frame (Bₜ) according to a predetermined similarity measure;
calculating a raw set of motion parameters (M_{t,i}^{p}) describing the motion between the segment (S_{t,i}) of the first video frame (Bₜ) and the corresponding predicted segment (S_{t+1,i}^{p,forward}) of said second video frame (Iₜ₊₁); and
for each corresponding predicted segment (S_{t+1,i}^{p,forward}) of the second video frame (Iₜ₊₁):
searching, in the first video frame (Bₜ), a corresponding segment (S_{t+1,i}^{p,backward}) that matches with the predicted segment (S_{t+1,i}^{p,forward}) of the second video frame (Iₜ₊₁) according to a predetermined similarity measure;
calculating a best set of motion parameters (M_{t,i}^{p}+ΔM_{t,i}^{p}) describing the motion between the corresponding segment (S_{t,i}^{p,backward}) of the first video frame (Bₜ) and the predicted segment (S_{t+1,i}^{p,forward}) of the second video frame (Iₜ₊₁), said best set of motion parameters consisting in the raw set of motion parameters (M_{t,i}^{p}) corrected by a motion parameters correction (ΔM_{t,i}^{p}).

2. A method according to claim 1, characterized in that it includes a step of calculating a residual frame (Rₜ₊₁) for the second video frame (Iₜ₊₁) describing the structural differences between the first video frame (Bₜ) and the second video frame (Iₜ₊₁).

3. A method according to claim 1, characterized in that it includes a step of calculating a set of overlapping parameters for each predicted segment (S_{t+1,i}^{p,forward}) resolving the intersections between said predicted segment (S_{t+1,i}^{p,forward}) and adjacent other predicted segments of the second video frame (Iₜ₊₁).

4. A method according to claim 1, characterized in that it includes a step of calculating, for each video frame (Bₜ₊₁), a set of overlapping parameters resolving the intersections between the predicted segments of the second video frame (Iₜ₊₁).

5. A method according to claim 1, characterized in that the first video frame (Bₜ) is a decompressed video frame corresponding to a frame (Iₜ) of the video sequence processed by said compression method and the corresponding decompression method.

6. A method according to claim 1, characterized in that the best set of motion parameters (M_{t,i}^{p}+ΔM_{t,i}^{p}) is defined according to a multi-layer motion description in which a first layer contains the raw set of motion parameters (M_{t,i}^{p}) and a second layer contains the motion parameters correction (ΔM_{t,i}^{p}), the information of the first and second layers being distinguished.

7. A method according to claim 6, characterized in that it includes a step of setting a flag to a first or a second predetermined value indicating whether the motion parameters correction (ΔM_{t,i}^{p}) has to be used for the video information decompression.

8. A method according to claim 1, characterized in that it includes a step of determining a set of segmentation parameters defining the segmentation process implemented for segmenting the first video frame (Bₜ) into segments (S_{t,i}).

9. A method for decompressing video information in a video sequence (Iₜ, Iₜ₊₁) comprising:
considering a first video frame (Bₜ) containing image data;
segmenting said first video frame (Bₜ) into segments (S_{t,i});
for each segment (S_{t,i}) of the first video frame (Bₜ), defining a projected segment (S_{t+1,i}^{p}) by applying to the segment (S_{t,i}) of the first video frame (Bₜ), a raw set of motion parameters (M_{t,i}^{p}) describing the motion between the segment (S_{t,i}) of the first video frame (Bₜ) and the corresponding projected segment (S_{t+1,i}^{p}) and
for each corresponding projected segment (S_{t+1,i}^{p}):
finding in the first video frame (Bₜ) a corresponding improved segment (S_{t,i}^{b}) using both the raw set of motion parameters (M_{t,i}^{p}) and a motion parameters correction (ΔM_{t,i}^{p}), the corresponding improved segment (S_{t,i}^{b}) being the segment of the first video frame (Bₜ) that would be projected on the corresponding projected segment (S_{t+1,i}^{p}) by applying to it the raw set of motion parameters (M_{t,i}^{p}) corrected by the motion parameters correction (ΔM_{t,i}^{p}); and
defining a corrected projected segment (S_{t+1,i}^{p,o,c}) by applying the raw set of motion parameters (M_{t,i}^{p}) corrected by the motion parameters correction (ΔM_{t,i}^{p}) to the corresponding improved segment (S_{t,i}^{b}).

10. A method according to claim 9, characterized in that it includes the steps of:
considering a flag in the video information; and
calculating a corrected projected segment (S_{t+1,i}^{p,o,c}) by applying the raw set of motion parameters (M_{t,i}^{p}) corrected by the motion parameters correction (ΔM_{t,i}^{p}) to the corresponding improved segment (S_{t,i}^{b}) if said flag has a first predetermined value and not calculating a corrected projected segment (S_{t+1,i}^{p,o,c}) if said flag has a second predetermined value.

11. A method according to claim 9, characterized in that it includes a step of applying a set of overlapping parameters to the projected segments (S_{t+1,i}^{p}) resolving the intersections between the adjacent projected segments (S_{t+1,i}^{p}).

12. A method according to claim 9, characterized in that the step of segmentation of said first video frame (Bₜ) into segments (S_{t,i}) includes a step of applying a set of segmentation parameters contained in the video information and defining the segmentation process implemented for segmenting the first video frame into segments (S_{t,i}) during the compressing stage.

13. A computer program product for a data processing unit, comprising a set of instructions, which, when loaded into said data processing unit, causes the data processing unit to carry out the method claimed in claim 1.

14. A device for compressing video information in a video sequence (Iₜ, Iₜ₊₁) comprising:
means for segmenting the first video frame (Bₜ) containing image data into segments (S_{t,i});
means for searching, in a second video frame (Iₜ₊₁) following the first video frame (Bₜ) in the video sequence, a corresponding predicted segment (S_{t+1,i}^{p,forward}) which matches with the segment (S_{t,i}) of the first video frame (Bₜ) according to a predetermined similarity measure, for each segment (S_{t,i}) of the first video frame (Bₜ);
means for calculating a raw set of motion parameters (M_{t,i}^{p}) describing the motion between the segment (S_{t,i}) of the first video frame (Bₜ) and the corresponding predicted segment (S_{t+1,i}^{p,forward}) of the second video frame (Iₜ₊₁), for each segment (S_{t,i}) of the first video frame (Bₜ);
means for searching, in the first video frame (Bₜ), a corresponding segment (S_{t,i}^{p,backward}) that matches with the predicted segment (S_{t+1,i}^{p,forward}) of the second video frame (Iₜ₊₁) according to a predetermined similarity measure, for each corresponding predicted segment (S_{t+1,i}^{p,forward}) of the second video frame (Iₜ₊₁);
means for calculating a best set of motion parameters (M_{t,i}^{p}+ΔM_{t,i}^{p}) describing the motion between the corresponding segment (S_{t,i}^{p,backward}) of the first video frame (Bₜ) and the predicted segment (S_{t+1,i}^{p,forward}) of the second video frame (Iₜ₊₁), said best set of motion parameters consisting in the raw set of motion parameters (M_{t,i}^{p}) corrected by a motion parameter correction (ΔM_{t,i}^{p}), for each corresponding predicted segment (S_{t+1,i}^{p,forward}) of the second video frame (Iₜ₊₁).

15. A device for decompressing video information in a video sequence (Iₜ, Iₜ₊₁) comprising:
means for segmenting said first video frame (Bₜ) containing image data into segments (S_{t,i});
means for defining a projected segment (S_{t+1,i}^{p}) for each segment (S_{t,i}) of the first video frame (Bₜ), by applying to the segment (S_{t,i}) of the first video frame (Bₜ), a raw set of motion parameters (M_{t,i}^{p}) describing the motion between the segment (S_{t,i}) of the first video frame (Bₜ) and the corresponding projected segment (S_{t+1,i}^{p});
means for finding, in the first video frame (Bₜ), a corresponding improved segment (S_{t,i}^{b}) using both the raw set of motion parameters (M_{t+1,i}^{p}) and a motion parameters correction (ΔM_{t,i}^{p}), the corresponding improved segment (S_{t,i}^{b}) being the segment of Bₜ that would be projected on the corresponding projected segment (S_{t+1,i}^{p}) by applying to it the raw set of motion parameters (M_{t,i}^{p}) corrected by the motion parameters correction (ΔM_{t,i}^{p}), for each corresponding projected segment (S_{t+1,i}^{p}); and
means for defining a corrected projected segment (S_{t+1,i}^{p,o,c}) by applying the raw set of motion parameters (M_{t,i}^{p}) corrected by the motion parameters correction (ΔM_{t,i}^{p}) to the corresponding improved segment (S_{t,i} ^{b}), for each corresponding projected segment (S_{t+1,i}^{p}).

16. Compressed data corresponding to a video sequence, characterized in that it has been obtained by a compression method according to claim 1 and applied on said video sequence.
